(19) United States
(12) Patent Application Publication
(10) Pub. No.: US 2022/0058563 A1
(43) Pub. Date: Feb. 24, 2022

(54) PROCEDURAL SERVICE MATCHING METHOD

(71) Applicant: DOCTOR A COMPANY LIMITED, Icheon-si, Gyeonggi-do (KR)

(72) Inventor: Yun Suk SEO, Seoul (KR)

(73) Assignee: DOCTOR A COMPANY LIMITED, Icheon-si, Gyeonggi-do (KR)

(21) Appl. No.: 17/275,961

(22) PCT Filed: Oct. 18, 2019
(86) PCT No.: PCT/KR2019/013760

§ 371 Date: Mar. 12, 2021

(30) Foreign Application Priority Data
Oct. 18, 2018 (KR) 10-2018-0124198

(51) Int. Cl. G06Q 10/06; G06Q 30/02; G06N 20/00

(52) U.S. Cl. CPC G06Q 10/063112; G06N 20/00; G06Q 30/0282

(57) ABSTRACT

The present invention relates to a procedural service matching method for matching a variety of procedural services, including massages, beauty care, hair care, health care, etc. between consumers and businesses operators, whereby a service that can match professional procedural cosmetologists and consumers one-to-one can be provided so as to create an environment in which licensed procedural cosmetologists can freely engage in economic activities (as freelancers), and a differentiated and specialized multi-beauty cultural space can be provided.

### FIELD OF INVENTION

The present invention relates to a surgical procedure service matching method, in particular, to a procedure service matching method to match various beauty procedure (“procedure”) services including massage, beauty care, hair management, health care, etc. between a consumer and a business operator (that is, “operator”).

### BACKGROUND OF INVENTION

Since a person's skin generally changes according to age, body condition, constitution and seasonal changes, cosmetics and a care method should be carefully selected after correctly determining the condition of the skin case-by-case. Therefore, as understood from the growth evolution of functional cosmetics, consumer desire to look young is expanding and a variety of procedure services including beauty services are being developed along with rapid growth of the beauty industry. However, in order to obtain beauty care functions and cosmetic provision/sales functions based on skin conditions of individuals, there are inconveniences in that each individual should separately contact a beautician who manages a beauty care service or a visiting salesperson who sells cosmetics and then receive beauty care service from the beautician or must purchase cosmetics from the visiting salesperson.

Further, in the case of a beauty technician who does not have a procedure shop or any place of business in which the procedure can be provided, it is substantially difficult to secure a space for performing a beauty procedure on consumer(s).

Further, in the case of a business person who does not perform the procedure directly, there is currently no means to provide various beauty consulting services (cosmetics, beauty care, beauty products, health supplements, etc.) to consumers.

Accordingly, there is a need for efficient matching between beauty technicians and consumers, that is, efficient matching between consumer-technician, consumer-business person and technician-business person is urgently required.

### SUMMARY OF INVENTION

### Technical Problem to be Solved

The technical object of the present invention is to provide 1:1 matching service between a professional procedure manager (“technician”) and a consumer.

Further, another object of the present invention is to provide a means enabling sharing of a procedure place even if no independent workplace is secured.

### Technical Solution

An embodiment of the present invention may include: a technician information registration process that registers at least one piece of user information including, for example, whether the technician has a procedure shop or not, procedure shop information, technician contact information, procedure experience, procedure types, technician issues, procedure cost, a schedule of the technician, etc., with a procedure matching server through a terminal of the technician who provides the procedure service; a consumer information registration process that registers at least one piece of consumer information including an address of a consumer, consumer contact information, procedure types, consumer issues, cost of desired procedure, desired procedure time, etc. with the procedure matching server through a terminal of the consumer who wishes to receive the procedure service; a business person (“operator”) information registration process that registers operator information including an address of the operator and desired rental fee with the procedure matching server through a terminal of the operator who provides a procedure space; a matching process in the procedure matching server that performs matching between the consumer and the technician, matching between the consumer and the operator, and/or matching between the technician and the operator, under a matching condition set using the technician information, the consumer information and/or the operator information; and a process of providing the matching information in the procedure matching server that provides the technician with the matched consumer information through the technician terminal, while providing the consumer with the matched technician information through the consumer terminal.

After provision of the matching information, a process for registration of consumer ratings, wherein the procedure matching server receives a procedure evaluation review from the consumer terminal and then calculates and registers a consumer rating for each technician using the obtained procedure evaluation review, may be further included.

The matching process may be implemented using location-based matching such that the consumer and the technician are matched in the order of technicians located closest to the consumer address, the consumer and the operator are matched in the order of operators located closest to the consumer address, or otherwise, the technician and the operator are matched in the order of operators located closest to the technician address.

The matching process may be implemented using consumer rating-based matching such that the consumer and the technician are matched in the order of technicians having the highest consumer rating, the consumer and the operator are matched in the order of operators having the highest consumer rating, or otherwise, the technician and the operator are matched in the order of operators having the highest technician rating.

The matching process may be implemented using issue-based matching such that the consumer is matched with the technician who is matched on the basis of the procedure issue selected by the consumer, the consumer is matched with the operator who is matched on the basis of the procedure issue selected by the consumer, or otherwise, the technician is matched with the operator who is matched on the basis of the procedure issue selected by the technician.

The matching process may be characterized by AI/big data-based matching that utilizes artificial intelligence analysis and big data analysis.

The matching between the consumer and the operator may be characterized by matching beauty consulting services including cosmetics, beauty equipment, beauty supplies and health supplements provided by the operator to the consumer.

The matching between the technician and the operator may be characterized in that, in the case of the technician who does not have a procedure shop, other workplaces of operators in which the procedure can be conducted (“procedure-possible workplaces”) are searched in consideration of the desired time for procedure, and then, the selected one among the procedure-possible workplaces is matched as the procedure shop.

### Effect of Invention

According to the embodiment of the present invention, a service capable of one-to-one (1:1) matching between a professional procedure manager (that is, technician) and a consumer may be provided, thereby creating or establishing an environment in which licensed procedure technicians can conduct autonomous economic activities (freelancing).

Further, according to the embodiment of the present invention, a differentiated and specialized multi-beauty culture space can be provided.

### BRIEF DESCRIPTION OF DRAWINGS

FIG. 1 is a block diagram illustrating a procedure service matching system according to an embodiment of the present invention.

FIG. 2 is a block diagram illustrating a terminal including a technician terminal and a consumer terminal according to an embodiment of the present invention.

FIG. 3 is a diagram illustrating effects of the procedure service matching method according to an embodiment of the present invention.

FIG. 4 is a flowchart showing a procedure service matching method according to an embodiment of the present invention.

FIG. 5 is a flowchart showing registration of technician information and consumer information according to an embodiment of the present invention.

FIG. 6 is a diagram illustrating a consumer terminal to receive a procedure evaluation review of a consumer according to an embodiment of the present invention.

FIG. 7 is a diagram illustrating a state in which matching is performed using location-based matching according to an embodiment of the present invention.

FIG. 8 is a diagram illustrating a state in which matching is performed using consumer rating-based matching according to an embodiment of the present invention.

FIG. 9 is a diagram illustrating a state in which matching is performed using issue-based matching according to an embodiment of the present invention.

### BEST MODE

Hereinafter, advantages and features of the present invention, and methods for achieving the same will be clarified with reference to embodiments described below in detail together with the accompanying drawings. However, the present invention is not limited to the embodiments disclosed below but will be implemented in different forms, and is provided to completely inform those skilled in the art to which the present invention belongs. As such, the invention is only defined by the scope of the appended claims. If well-known technologies are considered to obscure the subject matter of the present invention, detailed descriptions thereof will be omitted.

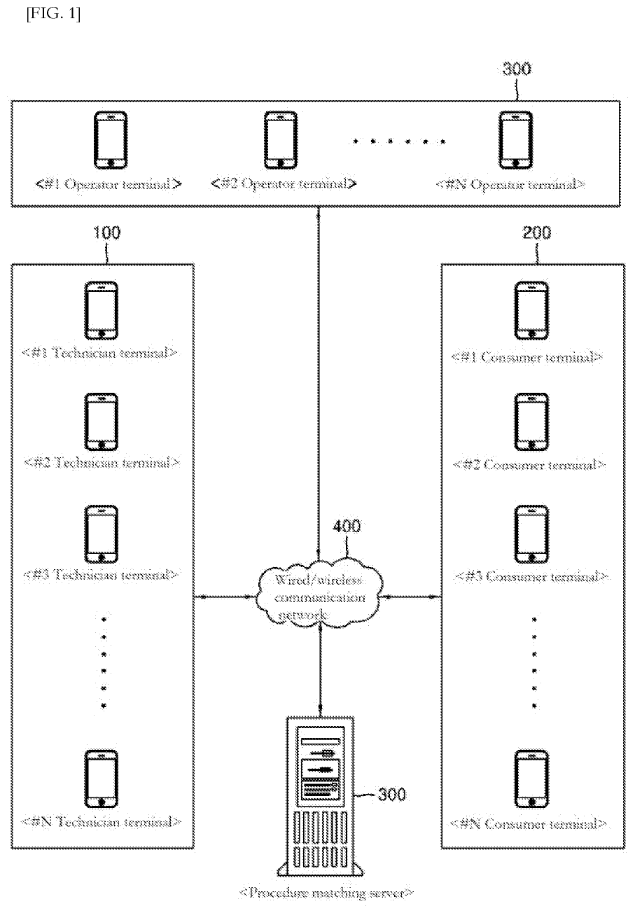

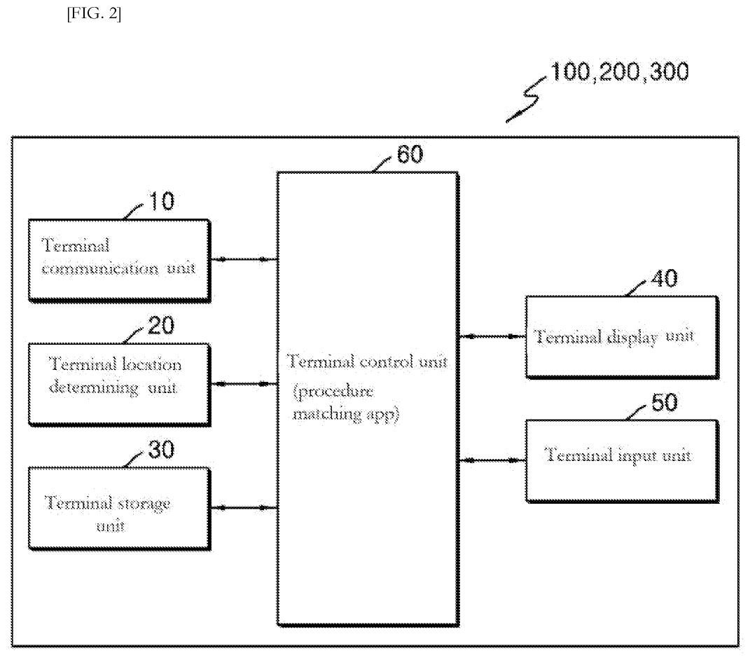

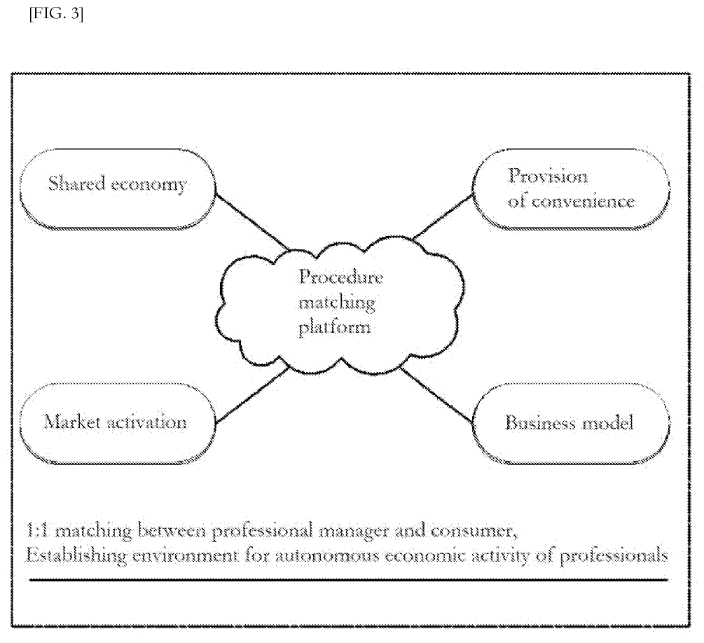

FIG. 1 is a block diagram illustrating a procedure service matching system according to an embodiment of the present invention, FIG. 2 is a block diagram illustrating a terminal including a technician terminal and a consumer terminal according to an embodiment of the present invention, and FIG. 3 is a diagram illustrating effects of the procedure service matching method according to an embodiment of the present invention.

In the present specification, the term “procedure service” is a concept including all forms of commerce activities that provide a procedure service at a price, that is, a combination of a service and an article, for example, massage, beauty care, hair management, health care and the like.

The procedure service matching system of the present invention may include a wired/wireless communication network 500, a technician terminal 100, a consumer terminal 200, an operator terminal 300 and a procedure matching server 400.

The wired/wireless communication network 500 is a communication network that provides wired communication or wireless communication between the technician terminal 100, the consumer terminal 200 and the procedure matching server 400. When the wired/wireless communication network 500 is implemented as a wireless communication network, a wireless mobile communication network consisting of a base transceiver station (BTS), a mobile switching center (MSC), and a home location register (HLR) may be used to execute data communication. Alternatively, if the wired/wireless communication network 500 is implemented as a wired communication network, data communication may be executed by internet protocol including transmission control protocol/internet protocol (TCP/IP).

The technician terminal 100 is a terminal used by a technician (as a freelancer) who provides a procedure service. The technician terminal 100 may register one or more pieces of technician information including, for example, whether the technician has a procedure shop or not, procedure shop information, technician contact information, procedure experience, procedure type, technician issues, procedure cost, a schedule of the technician, etc. with the procedure matching server 400.

The consumer terminal 200 is a terminal used by a consumer who receives a procedure service. The consumer terminal 200 may register one or more pieces of consumer information including, for example, a consumer address, consumer contact information, procedure types, consumer issues, desired procedure cost, and desired procedure time, etc. with the procedure matching server 400.

The operator terminal 300 is a terminal used by an operator who can provide a procedure space for beauty procedure service. Such an operator may provide beauty consulting services including cosmetics, beauty equipment, beauty products and health supplements.

Each of the technician terminal 100, the consumer terminal 200 and the operator terminal 300 has been illustrated as a smartphone in the drawings, but not being limited to the smartphone and also including a desktop PC and a tablet, a notebook computer, and the like. Further, the terminal to which the present invention is applicable is not particularly limited to the above-described types, and may of course include all kinds of terminals capable of communicating with external devices.

Each of the technician terminal 100, the consumer terminal 200 and the operator terminal 300, as shown in FIG. 2, may include a terminal communication unit 10, a terminal location determining unit 20, a terminal storage unit 30, a terminal display unit 40, a terminal input unit 50 and a terminal control unit 60.

The terminal communication unit 10 is a module that executes a function of communicating through a mobile communication network and, when performing 3G or 4G mobile communication, etc., an RF transmitter (not shown) for up-converting and amplifying a frequency of a wirelessly transmitted signal, an RF receiver (not shown) for amplifying the received radio signal with low noise and for down-converting the frequency, or the like, may be further included.

The terminal location determining unit 20 is a module that determines a location of the terminal. This may receive GPS terminal information from GPS satellites to determine a location of the terminal, may determine the location of the terminal based on a location of a mobile communication base station, or may determine the location of the terminal based on a beacon location which is detected through beacon communication from a nearby beacon device.

The terminal storage unit 30 is a storage device in which an execution program of a specific procedure matching application (“app”) according to the present invention, graphical user interface (GUI) information, etc. have been stored. Such a storage device is a module capable of inputting and outputting information, including a flash memory, a compact flash card (CF card), and a secure digital card (SD card), etc., which may be integrated in the device or may be provided in a separate device.

The terminal display unit 40 is a module in which the matched technician information or consumer information is displayed.

The terminal input unit 50 is a module that receives at least one piece of technician information including, for example, whether the technician has a procedure shop or not, procedure shop information, technician contact information, procedure experience, procedure types, technician issues, procedure cost, a schedule of the technician, etc. in case of the technician terminal 100; or, at least one piece of consumer information including, for example, a consumer address, consumer contact information, procedure types, consumer issues, desired procedure cost, and desired procedure time, etc. in case of the consumer terminal 200. The terminal input unit 50 and the terminal display unit 40 may be implemented in a single form of a touch screen panel. The touchscreen panel may be a display window provided in front of the terminal, which provides a touch screen functioning to simultaneously allow input and output, shows a working condition and displays a graphical user interface (GUI) for communication.

The terminal control unit 60 is implemented as a main control unit (MCU) to control separate function modules of the terminal, and refers to a module in which the procedure matching app according to the present invention has been installed. For reference, a smartphone may be used as the technician terminal 100 or the consumer terminal 200. Therefore, hundreds of different applications (apps) may be installed in the terminal and added to or deleted from the terminal, as desired by the user. Further, the user may directly create their own applications and may also implement desirable interfaces suitable for themselves through various applications (apps). Accordingly, the user can download the procedure matching app from Google Play, the Apple App Store, etc., and can install the same on their smartphones.

The procedure matching server 400 may perform 1:1 matching between the consumer and the technician under a matching condition set using the technician information and the consumer information, and then, may provide the matched consumer information to the technician through the technician terminal 100 while providing the matched technician information to the consumer through the consumer terminal 200.

As shown in FIG. 3, according to the matching between the consumer and the operator, a shared economy, provision of convenience, market activation and a business model can be constructed.

1) Shared economy (autonomous economic activity of beauty-related professional technicians or beauticians)
Supporting economic activities of beauty-related workers (freelancers)
Matching professional workers including hairdressers, skin care workers, manicurists, makeup artists, therapists, artists, etc.

2) Provision of convenience (provision of PC and mobile platform)
Activating procedure services by providing a convenient platform to receive the service regardless of the location
Providing convenient search function through user's location base (GPS)

3) Market activation (by matching beauty-related professional technicians and consumers)
Procedure service (beauty service) through O2O platform that allows the consumer to receive the procedure service without burden, while increasing the number of consumers and sales income of procedure workers

4) Creation of business model (operation of advertising costs for entering the O2O platform)
Creating a business model by advertising management for activities of beauticians and beauty operators to enter O2O platform

### Preferred Embodiments of Invention

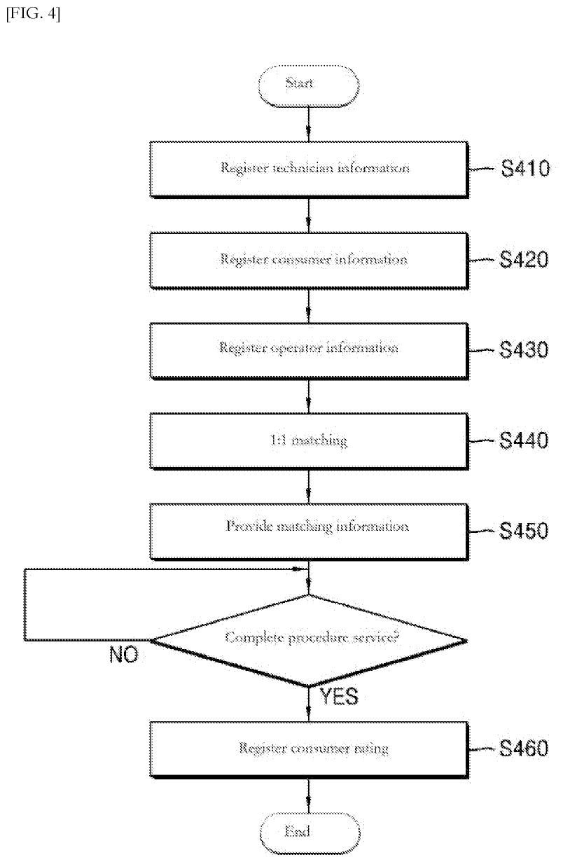

FIG. 4 is a flowchart showing a procedure service matching method according to an embodiment of the present invention;

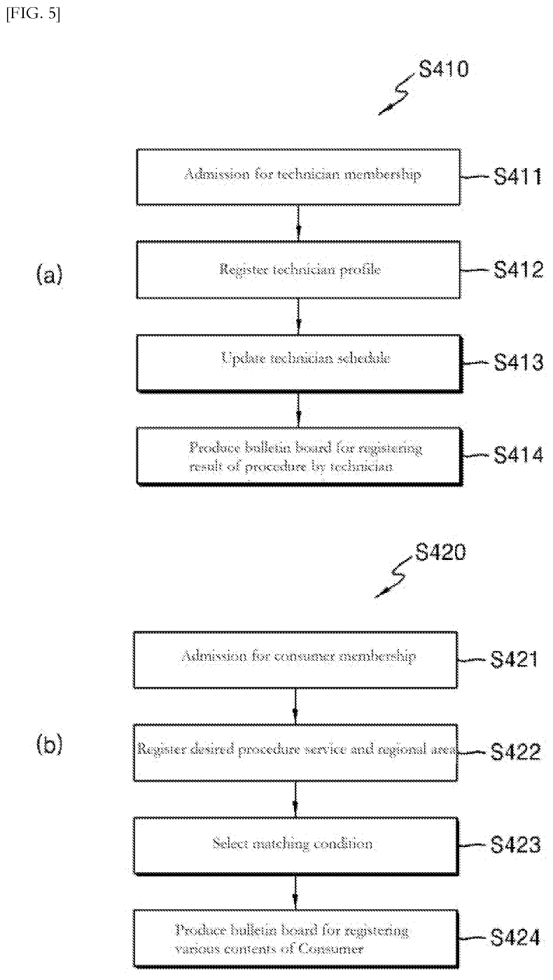

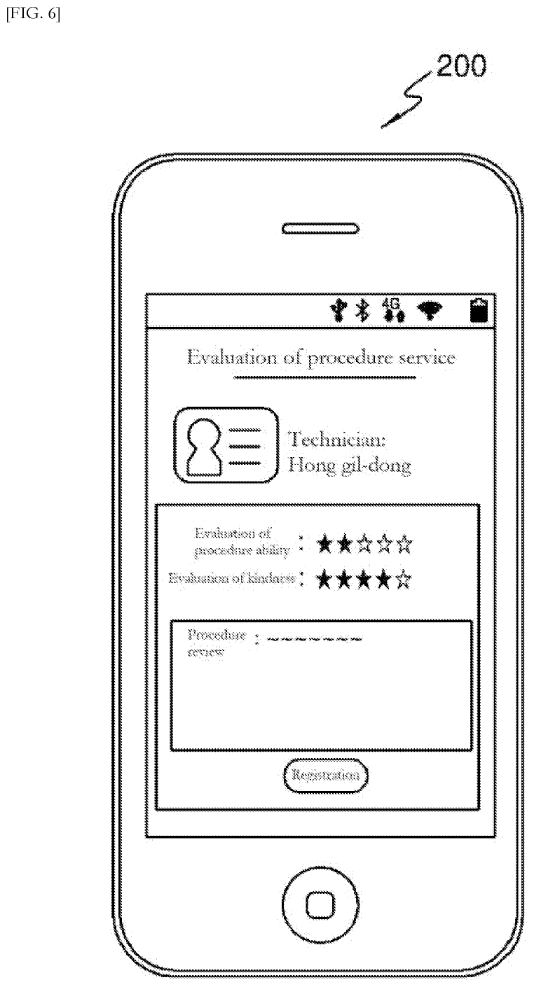

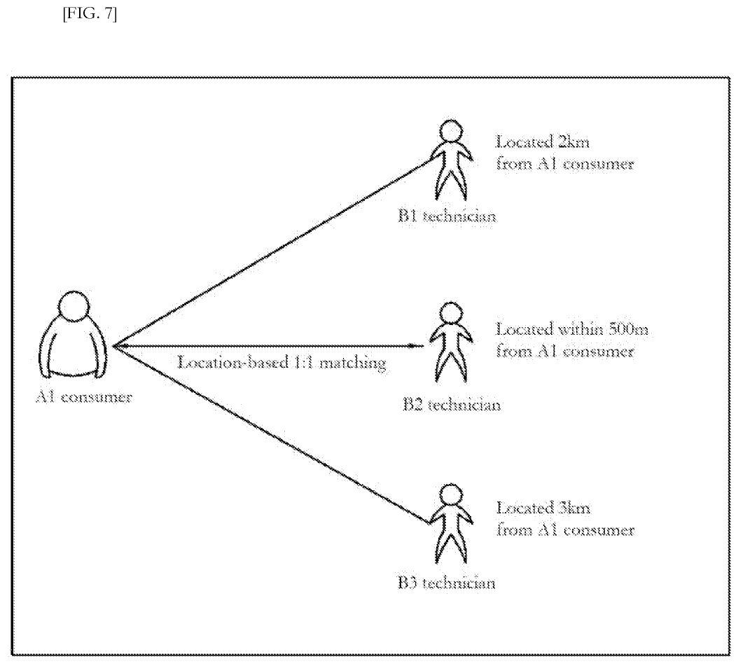

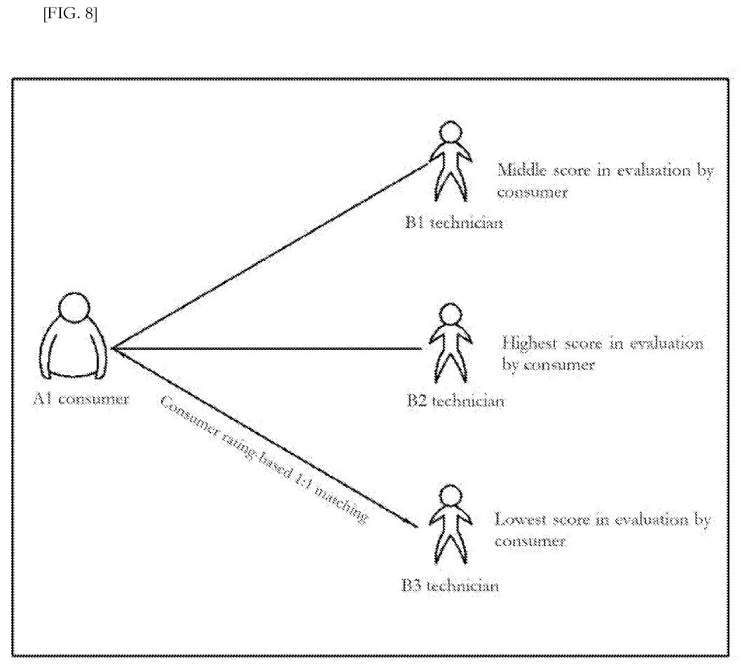

FIG. 5 is a flowchart showing registration of technician information and consumer information according to an embodiment of the present invention; FIG. 6 is a diagram illustrating a consumer terminal receiving a procedure evaluation review of a consumer according to an embodiment of the present invention; FIG. 7 is a diagram illustrating a state in which the matching is performed using location-based matching according to an embodiment of the present invention; FIG. 8 is a diagram illustrating a state in which matching is performed using consumer rating-based matching according to an embodiment of the present invention; and FIG. is a diagram illustrating a state in which matching is performed using issue-based matching according to an embodiment of the present invention.

As shown in FIG. 4, the procedure service matching method of the present invention may include: a process for registration of technician information S410, which includes registering one or more technician information including whether the technician has a procedure shop or not, procedure shop information, technician contact information, procedure experience, procedure types, technician issues, procedure cost, a schedule of the technician, etc. with a procedure matching server 400 through a technician terminal 100 used by a procedure service provider; a process for registration of consumer information S420, which includes registering one or more pieces of consumer information including a consumer address, consumer contact information, procedure types, consumer issues, desired procedure cost, and desired procedure time, etc. with the procedure matching server 400 through a consumer terminal 200 used by a consumer who wishes to receive the procedure service; a process for registration of business information S430, which includes registering operator information including an operator address, desired space rental fee, etc. with the procedure matching server through an operator terminal used by an operator who provides the procedure space; a matching process S440, which includes 1:1 matching between the consumer and the operator by the procedure matching server 400 under a matching condition set using the technician information and the consumer information; and a process for provision of matching information S450, which includes providing the consumer information matched with the technician to the technician terminal 100 by the procedure matching server 400, and providing the technician information matched with the consumer to the consumer terminal 200 by the procedure matching server 400. In addition, a consumer rating registration process S460 may be further included. The above processes will be described in detail below.

The technician information registration process S410 is a process in which the technician terminal 100 used by the technician who provides a procedure service may register the technician information with the procedure matching server 400. Such technician information may include one or more among whether the technician has a procedure shop or not, procedure shop information, technician contact information, procedure experience, procedure types, technician issues, procedure cost, a schedule of the technician, etc.

As shown in FIG. 5a, the process for registration of technician information S410 to register the technician information with the procedure matching server 400 may include: application for admission S411 by inputting whether the technician has a procedure shop or not, procedure shop information, technician contact information, etc.; and inputting and registering technician profile (service introduction, experience, qualification information, procedure cost, etc.) S412. Further, the schedule of the technician is updated in real time to complete the registration S413. Moreover, a bulletin board for registering a result of the procedure by the technician may be produced S414.

The consumer information registration process S420 is a process in which the consumer terminal 200 used by the consumer who intends to receive the procedure service may register the consumer information with the procedure matching server 400. Such consumer information may include one or more among a consumer address, consumer contact information, procedure type, consumer issues, desired procedure cost, and desired procedure time, etc.

As shown in FIG. 5b, the consumer information registration process to register the consumer information with the procedure matching server 400 may include: application for admission S421; and selecting and inputting a desired procedure service and regional area S422. Then, matching conditions should be selected S423. Moreover, a registration bulletin board for registering various contents of the consumer themselves may be produced S424.

The operator information registration process S430 is a process in which the operator terminal used by the operator who provides the procedure space may register the operator information including the operator address and the desired space rental fee with the procedure matching server.

The matching process S440 is a process in which the procedure matching server 400 may perform matching between the consumer and the technician, matching between the consumer and the operator, and matching between the technician and the operator under the matching conditions set using the technician information, the consumer information and the operator information.

In this case, the matching condition may comprise location-based matching, consumer rating-based matching, issue-based matching, and AI/big data-based matching.

The location-based matching is a matching condition that matches a consumer with the technician in the order of technicians located close to the consumer address. For instance, in the case of location-based matching, as shown in FIG. 7, B2 technician located closest to the address where A1 consumer resides may be matched. Therefore, the consumer can be provided with a procedure service from the technician closest to the consumer.

Further, the consumer rating-based matching is a matching condition that matches a consumer with the technician in the order of technicians having highest consumer ratings. For example, in the case of consumer rating-based matching, B3 technician having the highest consumer rating may be matched as shown in FIG. 8.

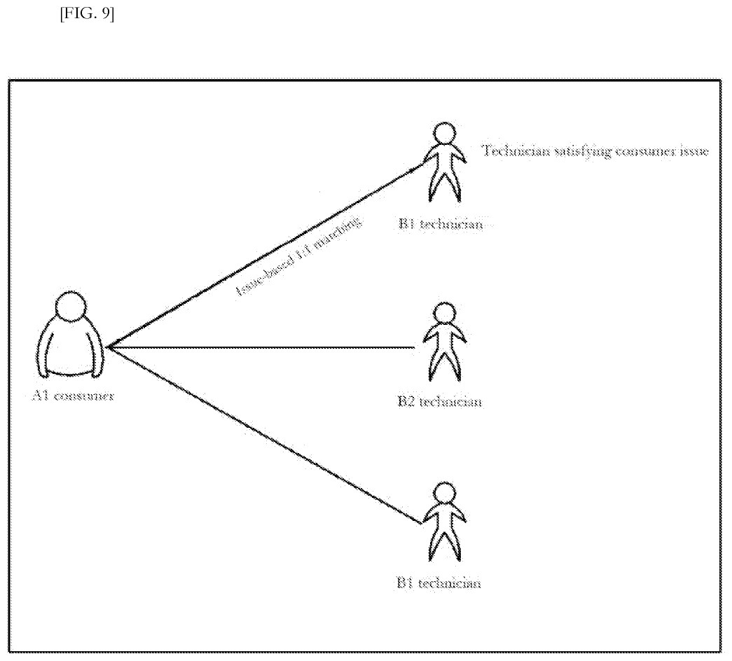

Further, the issue-based matching condition is an issue-based matching condition that matches a consumer with the technician matched on the basis of the issue selected by the consumer or the technician. For instance, as shown in FIG. 9, a technician who can provide a procedure service suitable for a consumer issue registered by the consumer may be matched with the consumer. Likewise, a consumer who can satisfy the technician issue registered by the technician may be matched with the technician. For instance, if the consumer issue (service goal?) is “improvement offreckles”, laser treatment causing the skin to become thinner is undesirable and, instead, the skin care technician is matched as a skin barrier strengthening solution.

In addition, the AI/big data-based matching is performed on AI/big data using artificial intelligence analysis and big data analysis.

Therefore, different matching processes may be performed as follows.

1) Matching Between Consumer and Technician

The consumer and the technician are matched under the matching condition set using the technician information and the consumer information. For example, the consumer may be matched with the technician located near the consumer (location-based matching), or matched with the technician in the order of highest consumer ratings (consumer rating-based matching), or matched with the technician who is matched on the basis of the issue selected by the consumer (issue-based matching).

2) Matching between consumer and operator

A consumer may be matched with an operator. Herein, an operator refers to a person having a workspace where a procedure can be performed, and it is not necessary to perform the procedure directly. In addition to providing a procedure space for technicians, the operator may provide a variety of beauty consulting services (cosmetics, beauty equipment, beauty products, health supplements, etc.) to the consumer. Therefore, from the perspective of the consumer, various beauty consulting services may be provided by the matched operator.

The matching between the consumer and the operator may include matching the consumer with the operator in the order of operators located closest to the consumer address (location-based matching), matching the consumer with the operator in the order of operators having highest consumer ratings (consumer rating-based matching), or matching the consumer with the operator who is matched on the basis of the issue selected by the consumer (issue-based matching).

3) Matching Between Technician and Operator

In the case of a technician who does not have a procedure shop, after searching for other workplaces of operators where the procedure can be executed, the selected workplace of an operator may be matched as a procedure place in consideration of desired procedure time.

This means that, if a technician does not have a procedure shop, the technician may be arranged or mediated to execute procedure in a workplace of any other operator where the procedure can be executed by registering the procedure experience of the technician. Of course, the technician should pay to use the rental procedure shop. Therefore, it is possible to provide an environment in which professional experts having licenses (procedural licenses) can autonomously conduct economic activities without obstacles in time or space. Individual spaces can be shared, thereby creating a new shared economy.

Such matching between the technician and the operator may include matching the technician with the operator in the order of operators located closest to the technician's address (location-based matching), matching the technician with the operator in the order of operators having highest technician ratings (consumer rating-based matching), or matching the consumer with the operator who is matched on the basis of the issue selected by the technician (issue-based matching).

The matching information provision process S450 is a process in which the procedure matching server 400 may provide the matched consumer information to the technician through the technician terminal 100, and also provide the matched technician information to the consumer through the consumer terminal 200. Therefore, when a technician including a beautician, a skin care manager, a nail artist, a makeup artist, a therapist, etc. is in contact with a consumer matched after registration, a reservation is confirmed after consultation with the consumer (determining the location and service content) and searching for space.

The consumer rating registration process S460 is a process in which the procedure matching server 400 may receive procedure evaluation reviews from the consumer terminal 200, and then, calculate and register a consumer rating for each technician using the provided procedure evaluation reviews. For instance, as shown in FIG. 6, after receiving the procedure service, the consumer can input a procedure evaluation review for the technician who performed the procedure service and register the same with the procedure matching server 400. Accordingly, a consumer may select a technician with good evaluation for procedure service using the testimonial reviews and consumer ratings registered by others.

Meanwhile, each of such location-based matching, consumer rating-based matching, issue-based matching and AI/big data-based matching may be performed along with addition of a weighting.

For example, assuming that a weighting to be added is calculated based on the total value ‘1’, if it is set that the location-based matching has a weighting of 0.2, the consumer rating-based matching has a weighting of 0.3 and the issue-based matching has a weighting of 0.5, and when 3 points are given to B technician as the first-ranking technician, 2 points are given to A technician as the second-ranking technician and 1 point is given to C technician as the third-ranking technician, all of them being matched using location-based matching, the location-based matching score is as follows: 2 points (location-based score)*0.2 (location-based weighting)=0.4 points for A technician; 3 points (location-based score)*0.2 (location-based weighting)=0.6 points for B technician; likewise, 1 point*0.2=0.2 points for C technician.

In the same manner, for each technician, a weighted consumer-based matching score and a weighted issue-based matching score may also be estimated. Eventually, the final matching ranking can be determined by summing location-based matching scores, consumer rating-based matching scores and issue-based matching scores for individual technicians, to which weightings are added.

The above-described embodiments in the description of the present invention are adopted among different practical examples and presented in order to assist in understanding of a person having ordinary skill in the art, and the technical scope of the present invention is not necessarily limited to or defined by these embodiments. Instead, various changes and modifications and other equivalent embodiments are possible without departing from the technical scope of the present invention.

1. A procedure service matching method, comprising:
a technician information registration process that registers at least one piece of user information including whether the technician has a procedure shop or not, procedure shop information, technician contact information, procedure experience, procedure types, technician issues, procedure cost, a schedule of the technician, etc., with a procedure matching server through a terminal of the technician who provides the procedure service;
a consumer information registration process that registers at least one piece of consumer information including an address of a consumer, consumer contact information, procedure types, consumer issues, cost of desired procedure, desired procedure time, etc. with the procedure matching server through a terminal of the consumer who wishes to receive the procedure service;
an operator information registration process that registers operator information including an operator address and desired space rental fee with the procedure matching server through a terminal of the operator who provides a procedure space;
a matching process in the procedure matching server that performs matching between the consumer and the technician, matching between the consumer and the operator, and/or matching between the technician and the operator, under matching conditions set using the technician information, the consumer information and/or the operator information; and
a process of providing the matching information in the procedure matching server that provides the technician with the matched consumer information through the technician terminal, while providing the consumer with the matched technician information through the consumer terminal.

2. The method according to claim 1, wherein, after providing the matching information, a process for registration of consumer ratings in which the procedure matching server receives a procedure evaluation review from the consumer terminal and then calculates and registers a consumer rating for each technician using the obtained procedure evaluation review, is further included.

3. The method according to claim 1, wherein the matching process is implemented using location-based matching such that the consumer and the technician are matched in the order of technicians located closest to the consumer address, the consumer and the operator are matched in the order of operators located closest to the consumer address, or the technician and the operator are matched in the order of operators located closest to the technician address.

4. The method according to claim 2, wherein the matching process is implemented using consumer rating-based matching such that the consumer and the technician are matched in the order of technicians having highest consumer ratings, the consumer and the operator are matched in the order of operators having highest consumer ratings, or the technician and the operator are matched in the order of operators having highest technician ratings.

5. The method according to claim 1, wherein the matching process is implemented using issue-based matching such that the consumer is matched with the technician who is matched on the basis of the procedure issue selected by the consumer, the consumer is matched with the operator who is matched on the basis of the procedure issue selected by the consumer, or the technician is matched with the operator who is matched on the basis of the procedure issue selected by the technician, and wherein the issue-based matching process further includes calculating a matching score for each technician, to which a weighting is applied.

6. The method according to claim 1, wherein the matching process consists of AI/big data-based matching that utilizes artificial intelligence analysis and big data analysis.

7. The method according to claim 1, wherein the matching between the consumer and the operator is characterized by matching beauty consulting services including cosmetics, beauty equipment, beauty supplies and health supplements provided by the operator to the consumer.

8. The method according to claim 1, wherein the matching between the technician and the operator further includes: in the case of the technician who does not have a procedure shop, searching other workplaces of operators in which the procedure can be conducted (“procedure-possible workplaces”) at a desired procedure time registered in the consumer terminal; and, if procedure-possible workplaces at the desired procedure time registered in the consumer terminal are found, matching one among the found and selected procedure-possible workplaces as a place for procedure service between the consumer terminal and the technician terminal.
